(19) United States
(12) Patent Application Publication
(10) Pub. No.: US 2004/0017587 A1
(43) Pub. Date: Jan. 29, 2004

(54) System and method for RMP printing

(76) Inventors: Steven M. Jaffe, Sunnyvale, CA (US); Claudia B. Jaffe, Sunnyvale, CA (US); Michieal L. Jones, Davis, CA (US); Gene M. Cohen, Solana Beach, CA (US)

Correspondence Address: Sheldon R. Meyer, FLIESLER DUBB MEYER & LOVEJOY LLP, Fourth Floor, Four Embarcadero Center, San Francisco, CA, 94111-4156, US

(21) Appl. No.: 10/443,221

(22) Filed: May 22, 2003

Related U.S. Application Data
(60) Provisional application No. 60/385,189, filed on May 30, 2002.

(51) Int. Cl. G06F 15/00; G06K 1/00

(52) U.S. Cl. 358/3.29; 358/1.9

(57) ABSTRACT

Patterns such as micro-patterns can be created on a surface using a resonant microcavity phosphor display, such as may be used with a cathode ray tube (RMP-CRT). An image can be processed by an image processor as a series of signals and provided to the resonant microcavity phosphor display or RMP-CRT, such as through a control box or control panel. The RMP-CRT scans an electron beam over a photo-sensitive material according to the series of signals. This electron beam can expose any photosensitive material on the surface so as to create a pattern or representation of the image in the photo-sensitive material. This process can be used in applications such as offset printing, as well as printing circuit board components, photoresist-covered substrates, photosensitive biological molecules, photosensitive chemical compounds, bioanalysis chips, and ink-sensitive plates.

### CLAIM OF PRIORITY

This application claims priority to U.S. Provisional Patent Application No. 60/385,189, filed May 30, 2002, (Attorney Docket No. QVIS-01073US0) entitled “SYSTEM AND METHOD FOR RMP PRINTING” by Steven M. Jaffe, et al., which is hereby incorporated herein by reference.

### CROSS-REFERENCED CASES

The following patents are cross-referenced and incorporated herein by reference:

U.S. Pat. No. 6,198,211 entitled “Resonant Microcavity Display,” by Steven M. Jaffe et al., filed May 6, 1998.

### FIELD OF THE INVENTION

The present invention relates to printing process utilizing a resonant microcavity having a phosphor active region.

### BACKGROUND

Offset Printing

In recent years the printing industry has gone through a dramatic evolution in technology. The basic procedure used to generate printed material involves first generating the artwork, such as by graphic design. A color separation of the artwork is then done, and the photographic film is prepared, typically involving a four-color separation. A printing plate is prepared from photographic film, such as by using a photographic impression process with a vacuum frame and a Hg-vapor lamp. After a proofing print run, changes or corrections are made to the artwork. Once the corrected film is recreated, a second plate is prepared. The print job can then be put into production. Depending on the complexity of the job and the backlog of work at any of the preparation points, the cycle time can be unacceptably long.

The introduction of the computer to implement graphic designs, perform color separations, and directly output photographic film has made a major impact in reducing cycle time resulting in a procedure known as computer-to-film (CTF) processing. Further innovations resulted in additional time saving by directly outputting a set of printing plates, thereby eliminating the need to prepare color-separated film. This process is known as computer-to-plate (CTP) processing.

In another approach, known as “direct imaging” or “DI”, the computer output is fed directly to a plate-producing mechanism built into the printing press. This approach eliminates the setup time associated with plate registration. Equipment redesigns to implement DI processing are intensive, requiring a plate-producing head for each color, plus an associated exposure energy source and drive mechanism for each head.

Offset printing is used almost exclusively within the printing industry as the single most effective method of producing printed matter for high volume requirements. Techniques have evolved over the past ten years to produce results in color lithography of unusually high clarity and definition, while at the same time significantly reducing costs. Color lithography requires, as a first step, the production of a set of four color-separated photographic films. The set includes one black plate, as well as a plate for each of the three primary colors used in the four-color printing process. These plates are used to produce press plates for use on a printing press to generate printed material.

The ink used in such a printing process has a uniform density. As such, a printing press cannot generate prints with graded tones of color. To produce a gradation of tone, the image depicted in each of the four films must be broken down into a series of dots. These dots are created at the camera stage by placing a photographic screen between the image and the film, thus producing what is referred to as a “halftone”, a misnomer used to identify the image obtained in this manner. The combination of these plates, used in tandem on a four-color press, produces a printed image possessing both the appearance of a gradation in color tone and that of the full color spectrum.

Many of the advances in the evolution of the four-color process are the result of advances in computer technology and software development. Extremely sophisticated software packages have been developed to resolve color images into appropriately sized halftones for each of the four films. These halftones create the desired optical illusion when combined in precision registration. Halftone film is normally resolved using one of the industry standards, which at present call for the use of 85, 150 or 200 line-screens. These numbers represent, in lines/inch, the number of co-ordinate lines upon which the dot arrays reside. Print quality improves as the line-screen increases. The limitation to using higher line-screen is not in the film (200 lines/in equates to 125 um spacing) but in the nature of the offset printing process. The printing process involves transferring several small dots of ink from a rubber blanket to a sheet of paper. As the size of the dots used in the process decreases, the number of ink-related problems increases. Eventually, the problems associated with small dot sizes rules out their use in a viable printing process. Fortunately, the naked eye is unable to distinguish finer detail than that achieved by using 200 line-screens.

Exposure equipment presently in wide use throughout the printing industry primarily utilizes a mercury vapor lamp as a light source. The initial cost of a mercury lamp power supply, including the shutter mechanism, is relatively high. Mercury vapor replacement lamps are not cheap, and typically only have a useful life of about 2000 hours.

Maskless Fabrication of Micro-Patterns

Micro-lithographic techniques currently find wide-spread application throughout the scientific and technical communities. The concept first found widespread use in the manufacture of the transistor. This concept rapidly matured to the demands of the integrated circuit and further to the requirements imposed by semiconductor memories and microprocessors containing upwards of 8 million transistors. Technology is evolving such that a microcircuit comprised of one billion transistors is likely in the foreseeable future.

The techniques of micro-lithography also extend into the realm of biotechnology. Over the past decade significant progress has been made in the micro-miniaturization of chemical and biological analyses. Microanalysis chips have been designed to miniaturize bench-top biochemical analyses within the nanoliter volumes of capillary networks etched into solid supports. Microanalysis chips allow the user to aliquot reagents, mix, incubate, separate and detect within a completely computer controlled environment. The user interface is the simple addition of reagents into wells that feed into capillary networks. Reagents or compounds to be screened for drug discovery, for example, can be sipped onto chips that house common reactants for repetitive serial analyses.

In both semiconductor and bio-technology industries the quest for smaller feature size has lead to more densely packed pattern configurations. These configurations place increased demands on all aspects of the technology, especially in the realm of micro-lithography. Within both the micro-electronic and bio-technology industries the requirement for increased numbers of successive patterning layers coupled with increased feature density inevitably results in rapidly spiraling design and production costs, as well as exceptionally long concept/production cycle times. Typically the procedure widely used to implement micro-patterned devices and/or tools lithographically involves creating a reversed image thin film metal mask of each of the patterns comprising the design-set. In more complex designs the number of layers in a design-set total several dozen masks. The cost of each mask is impacted by a multitude of factors, such as the cost of materials, yield factor, labor, and the machine time associated with stepping each mask feature. Some design-sets become prohibitively expensive and make impractical the evaluation of a proposed design concept.

The need to create a mask set can be overcome by an approach commonly called “Direct-Write” lithography. Using this approach, the need to have thin film masks is circumscribed by exposing a light sensitive surface, on which a pattern is to be developed, directly with light from either a mercury vapor lamp or an excimer laser source. This exposure can be done feature by feature or bit by bit in order to create the complete pattern. Unfortunately this approach results in inordinately long cycle times resulting from the addition of sequential exposures required to expose each pattern feature. Given the bit counts and number of masking layers, production through-put would be severely limited.

“Chips” for more highly parallel, if less complicated, reactions are known as microarrays for analyses where numerous and varied biological binding reactions are required. Such microarrays are most commonly used for a variety of hybridization studies for applications in SNP (single nucleotide polymorphism) analysis and expression studies. However they are becoming more and more commonplace in a broad range of drug discovery, genomic and proteomic analyses, as well as for diagnostic testing, whole genome mapping, haplotyping studies, and the like. Microarrays can composed of synthetic oligonuclotides, single or double stranded DNA or RNA, or proteinaceous material. They can be spotted (printed), synthesized in situ, or covalently bound pre-synthesized or modified binding molecules. Most commonly formed on silica, plastics, or silicon, they are also designed on a broad variety of other solid supports and can take the form of simple solid surfaces as well as capillaries, wells and various other cavities or orifices. Attachment sites to solid supports can occur in actual wells or virtual wells defined by differences in surface tension or some other novel coating to discriminate between attachment sites and non-modified surfaces. In addition, some microarrays consist of various biological agents, such as DNA base pairs which are formed at each site on the array.

Photolithography has been instrumental in the development of “chips” for bioanalysis. One of the most long-standing methods for the production of the microarrays employs numerous lithographic steps to form the synthetic oligonucleotide features on a solid support. Photolithography is also critical in designing and building arrays that include etched wells, etched capillaries, input and output ports and the like. Photolithography allows for feature sizes as small as submicron diameters for synthesized microarrays as well as for multidepth etching for novel fluid pumping mechanisms designed within miniature microanalysis style devices. It is also instrumental in creating differtial surface tension arrays when traditional phosphoramidite chemistry is combined with inkjet printing techniques to synthesize oligonucleotides within “virtual” wells created by the surface tension array. Masks must be used to synthesize any of the variety of biopolymers of interest on the surface of a microarray, as well as to build up a three dimensional multidepth structure of a microanalysis chip and to pattern surface tension arrays.

One such microarray, developed by Affymetrix of Santa Clara, Calif., is a “GeneChip” microarray that consists of 10,000 or more DNA fragments synthesized on a chip. Each binding element requires deposition and synthesis based on proprietary photochemistry. The numerous oligonucleotides of each oligomer require as many masks as the n-mer consists times the total number of elements possible to deposit at each synthesized feature. For example, one mask is required for each four bases in the synthesis of an oligonucleotide of length n. Therefore, n×4 masks, or 200 masks, are required to synthesize 50mers in an array by photolighography. These masks can cost on the order of $1000.00 each. They may be considered hard wiring for the fabrication, such that only one microarray design can be made with this set of masks. This applies to any photochemical synthesis of an oligo using serial attachment chemistry for parallel synthetic features on a 2-D array.

For example, Caliper Technologies of Mountain View, Calif., has developed “sipper chip” technology that requires multidepth channels or capillaries wet-etched into solid supports. The differential depth allows for on-chip control of regions of pressure or electrokineticallly driven flow and/or differential pumping speeds without the use of traditional pumping mechanisms. Each chip design, as well as each etch depth, requires photolithographic masks.

Photolithography typically requires a mask to allow for the blocking or exposure of various regions on the solid surface intended to be etched. A laser or high intensity light source is required to irradiate the masked support. Each step is complex and expensive, requiring mask design, construction, alignment, lithographic support and chemicals, exposure, development and quality control. Typical GeneChips presently cost on the order of one thousand dollars per part. “Customization” with regard to microarray chips means that each set of mask can be used for only one chip design. At this point in time, microarrays fabricated in this matter are too expensive to serve the majority of scientific community. Methods to simplify manufacture, improve reliability and minimize cost to the end user are commonly accepted needs in the field.

### BRIEF SUMMARY

Systems and methods in accordance the present invention can create patterns such as micro-patterns on a surface having a photosensitive matierl using a resonant microcavity phosphor display, such as can be used with a cathode ray tube (RMP-CRT). An image, such as may be captured by a still or video camera as well as computer-generated, can be processed by an image processor as a series of signals. These signals can then be provided to the resonant microcavity phosphor display or RMP-CRT, such as through a control box or control panel. The

RMP-CRT can scan an electron beam over the photosensitive material according to the series of signals. This electron beam can expose the photosensitive material on the surface so as to create a pattern or representation of the image in the photosensitive material. This process can be used in applications such as offset printing, as well as creating circuit board components, photoresist-covered substrates, photosensitive biological molecules, photosensitive chemical compounds, bioanalysis chips, and ink-sensitive plates, for example.

Other features, aspects, and objects of the invention can be obtained from a review of the specification, the figures, and the claims.

### BRIEF DESCRIPTION OF THE DRAWINGS

FIG. 1 is a diagram of a system in accordance with one embodiment of the present invention.

FIG. 2 is a diagram of the RMP-CRT of FIG. 1.

FIG. 3 is a side, cross-section view of a resonant microcavity display that can be used in accordance with embodiments of the present invention.

FIG. 4 is a diagram of a system utilizing an imaging camera, in accordance with one embodiment of the present invention.

FIG. 5 is a perspective view of a resonant microcavity that can be used in the systems of FIGS. 1 and 4.

### DETAILED DESCRIPTION

Offset Printing

In one embodiment of the present invention useful for offset printing, a measured amount of light is allowed to pass through film negatives to expose a printing plate. When the plates are exposed to light, a chemical reaction occurs that allows an ink-receptive coating to be activated. This can result in the transfer of the image from the negative to the plate.

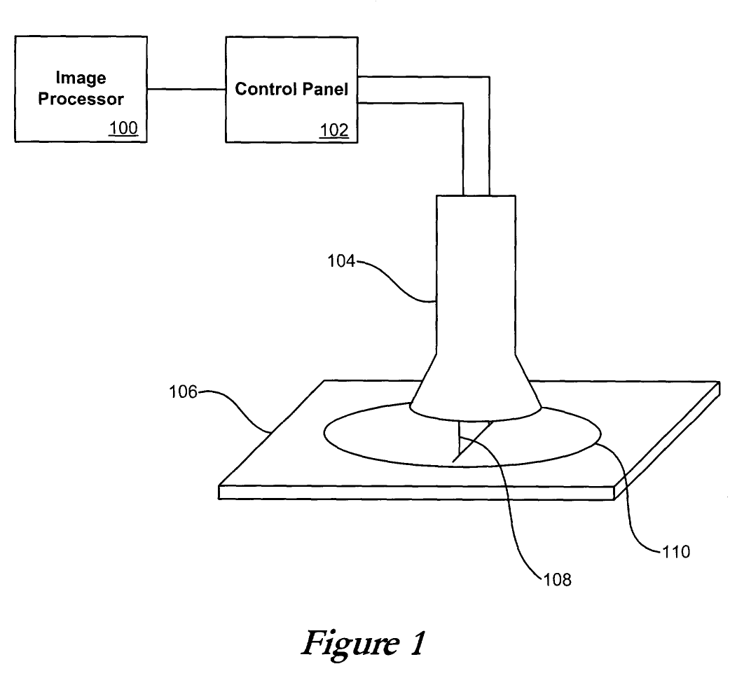

Computer-to-plate technology allows a digitally-stored image to be fed directly to an imaging system. As shown in FIG. 1, The image can be preprocessed in an image processor 100 such as a raster image processor, which can convert the image to a format that can be fed to an RMP-CRT 104 (Resonant Microcavity Phosphor-Cathode Ray Tube) as a series of on/off signals. The data can be used to modulate the intensity of the beam 108 projected by the RMP-CRT 104. The RMP-CRT 104 can receive the data through a control panel 102 or other control module. The beam 108 can scan over the surface of the plate 106, generating changes on the surface of the plate in the target area 110 or imaging area. Multiple passes over a surface can also be used, which can include a different series of signals for each pass, for example.

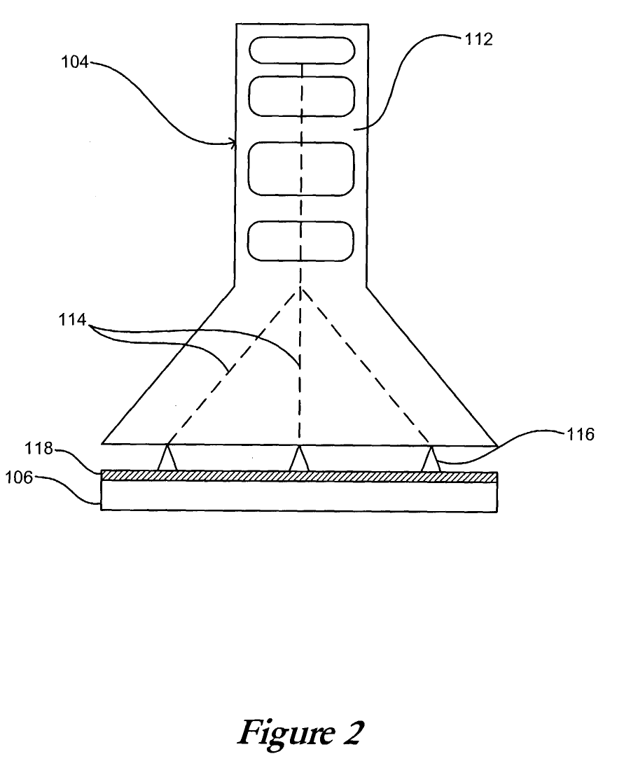

Certain plates utilize a two-layer polymer coating, for example, as shown in FIG. 2. A relatively thin top layer 118 can be exposed by a modulated light beam 116 from an RMP-CRT 104. An electron beam 114 in the electron gun 112 of the RMP-CRT 104 generates the modulated light beam 116. This thin top layer 118, where exposed, can be rendered permeable to the plate processing chemistry. For example, the plate can be dipped in an alkaline bath to allow the underlying layer 106 to be dissolved under the permeable upper layer 118. This can reveal desired portions or pattern on the plate, such as a grained aluminum plate. Proximity focus can be used to focus the light beams on the top layer or a photoreactive layer, although other optics or focusing methods can be used.

Offset printing can provide a high degree of color definition and can allow for physically larger items. A wide range of papers or other substrates can be used. A typical offset press can print on substrates ranging from 14″×20″, to 25″×38″, to 38″×50″, for example. The performance of an RMP-CRT for a given application depends on properties of the emitted light. Different properties will be appropriate for different applications, which can require different absorptions, exposure times, feature sizes, and feature densities. Properties of an RMP-CRT that can be adjusted to meet these requirements include the chromaticity, the directionality of the display, the luminous efficiency and the maximum light output of the display. Parameters that can be considered for optimization include the microcavity Q, the microcavity resonance frequency, the asymmetry of the reflectors, the resonator design (i.e., planar, confocal, multiple cavity, etc.), the phosphor, the thickness of the phosphor layer, the surface area of the microcavity and the excitation source.

For example, in designing a system for a specific application, a designer could first determine where the absorption will occur, such as in a photoresist layer, a biological molecule, or an ink-sensitive plate. This can determine which phosphor should be used, as different phosphors can be used to produce different color output for example. The designer can then determine the exposure time. This can determine how much power is to be delivered and how long the beam needs to write. The designer can then determine the necessary feature size and density. This can determine the necessary resolution and thus the appropriate electron gun, such as one that writes in a raster pattern, stroke pattern, or combination of the two. The designer can determine the size of pattern to be written, which can determine the number of CRTs necessary to cover that area, or can determine that a moveable stage needs to be used to allow a single CRT to cover the entire imaging area. The resolution needed can also determine whether a proximity focus or projection approach is used.

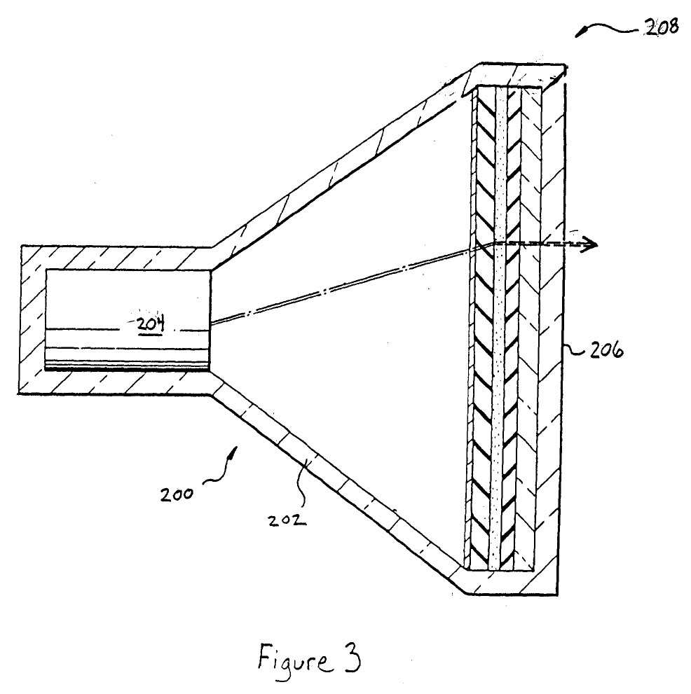

As seen in FIG. 3, a system and method in accordance with one embodiment of the present invention can utilize a cathode ray tube (CRT) 200 comprising a glass vacuum tube 202 enclosing an electron gun (which is a means to generate an electron beam) 204 aimed at a printing plate 206 and distal from the electron gun 204; and a phosphor-based resonant microcavity 208 disposed parallel to the flat printing plate 206 inside the vacuum tube 202. This CRT can be configured to produce monochromatic light.

Maskless Fabrication of Micro-Patterns

In another embodiment of the present invention, an RMP-CRT can be used, in conjunction with an image processor or video imaging camera, for example, to define micro-lithographic patterns using photo-resist materials on any of a variety of substrates upon which a photo-lithographic pattern may be suitably developed. These materials include, but are not limited to, silicon or other semi-conducting material, ceramic, glass, rigid and flexible polymers, semiconductor circuits and/or devices, integrated circuits, printed circuit boards, packages used as enclosures for electronic circuits and/or devices and chemical and biological analysis platforms.

Such a system can overcome objections to feature-by-feature exposure by employing the output of a video imaging camera or image processor to directly drive a RMP-CRT. This alternative to separate feature exposure enables the entire pattern to be exposed in a single pulse, directly from an enlarged image of the pattern, thus dramatically reducing pattern write-time. This can be accomplished without the need to create separate thin film masks of each layer in the design-set.

Direct-write approaches to micro-lithographic image reproduction have been limited by the need to use mercury vapor or excimer laser light sources to obtain UV spectrums with wavelengths suitable to the exposure of photo-resist materials into micron and/or submicron size dimensions. These light sources do not provide a raster output characteristic and are thus limited, in such an application, to sequential bit patterning. Utilizing an RMP-CRT, which can have an inherent raster output, can provide collimated light in the UV frequency range and is an ideal substitute light source enabling direct-write of a complete pattern for what would otherwise be a sequential bit-by-bit procedure. An RMP-CRT can use either a raster or stroke pattern, for example, with +/−0.1% stability.

As a first step in one method, using presently-accepted industry wide design procedures, a “Pattern Generator” (PG) file is created for the pattern to be photo-lithographically reproduced. This procedure was developed for use by the micro-electronics industry and is well known in the art. Information in the PG file is used to drive a chosen patterning mechanism, such as a commercially available plotter available from Gerber Scientific Products of Manchester, Conn., to create a hard image of the individual pattern level, i.e., art work. The output may take the form of, for example, an emulsion film photo plot, a machine cut rubylith foil, a pen/ink plot, or a glass reticle using thin film techniques. Alternatively, a hand drawn rubylith foil can be used in the instance where dimensional criteria are less demanding. Feature size, tolerance requirements and equipment availability, for example, can dictate which of the foregoing modes to select.

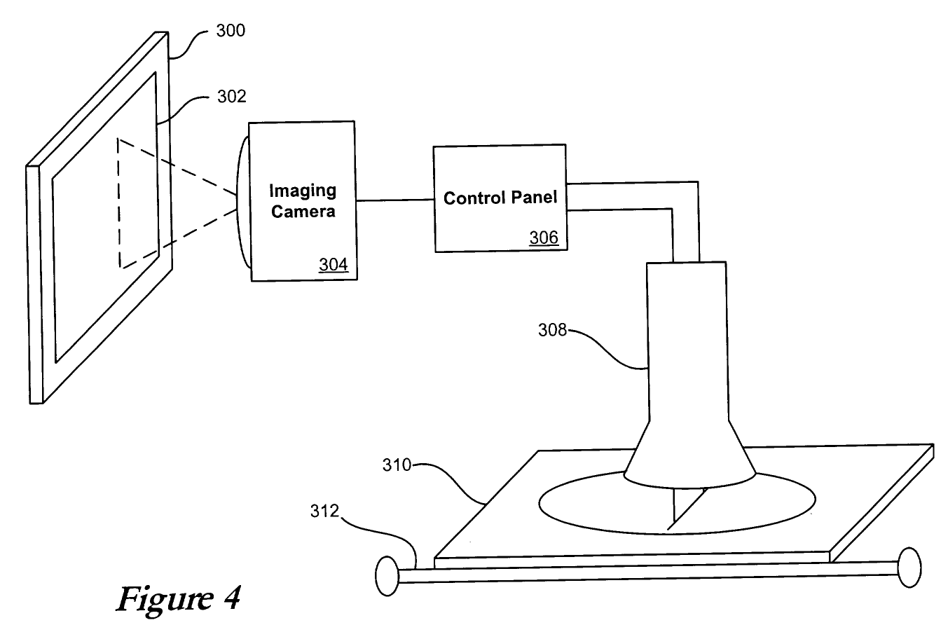

FIG. 4 shows the relation of certain system components to a substrate 310 containing a photoresist film on the surface of the substrate. In this embodiment, a vacuum frame 300 supports art work 302 and planarizes the art work to minimize surface distortions. It should be understood that any appropriate framing or posting method or device can be used to present an image to the camera or imaging device. A video imaging camera 304 is coupled to the RMP-CRT 308 through a control box 306. The control box, or control panel, provides timing instructions to the RMP-CRT and stepping mechanism 312. The stepping mechanism may be a step-and-repeat stage similar in design to any of the mechanisms currently employed by the multitude of equipment suppliers serving the semiconductor industry. If the system is to be used for either prototype fabrication or low volume production requirements, a hand advanced micro-manipulator stage can also be used.

One embodiment of an RMP-CRT system can be used in the lithographic production of chemical and biological analysis platforms. An RMP-CRT system is capable of facilitating a broad range of photolithographic processes for creating bioanalysis chips. The use of RMP-CRT's in the variety of fabrication processes required for biochip fabrication obviates the need for physical masks. Since an RMP-CRT is a electronic scanning device, any pattern can be written. This allows for complete customization without the expensive process of creating a mask, the various alignment steps, as well as the process chemistry and time per step.

The RMP-CRT allows for high intensity images at the correct wavelength. Its intrinsically collimated output provides high resolution and contrast. Unlike a conventional powder based CRT, a RMP-CRT can be used in stroke mode and generate high intensities without creating burn in images. Any permanent pattern would make a CRT device useless for lithographic production.

Features sizes can vary between about 250 and about 10 micron diameters, for example. Various physical ports, wells and capillaries are formed on the a variety of substrates including any combination of silica, silicon and plastic. A variety of chemical reagents and biological substances can be deposited as a function of specific location to form complex three-dimensional structures.

A RMP-CRT can be used to form physical and chemical features in biochips for microanalysis as well as microarrays. The emission can be extremely narrow, such as on the order of 0.25, and can cover a range from about 350 nm (ultraviolet) to about 1.5 microns or 2.0 microns (infrared), for example. The emission can also be multi-color, such as may be used with different photoresists. The output is highly directional with an divergence angle typically between 1 and 30 degrees, although light sources can be designed with angles of divergence from near zero degrees (normal to the emitting surface) to near horizontal. The use of a thin film phosphor results in extreme durability. The RMP-CRT can generate intensities of 10 W per cm² or higher depending on the phosphor and microcavity design. RMP-CRTs can generate spot sizes that can vary, for example, from at or above about 10 microns to about 1 mm or less.

As such, a RMP-CRT can be used to print various patterns on a solid support as well as synthesize chemical and biological polymers on a microarray. Depending on absorption property of the photosensitive material, a specific RMP-CRT can be designed to etch the pattern. Any pattern can be written on a CRT and thus any pattern can be created on the microarray. RMP-CRTs can be designed to generate one wavelength or multiple wavelengths in one device or a collection of devices.

The RMP-CRT can be placed directly above the microarray, or a surface to be wet-etched, for example, or the image can be transferred by optics. The latter can allow for the magnification and demagnifaction of the image. Resolution and intensity can be varied to accommodate a variety of irradiation requirements, such as may include spot size and feature cross-section.

As an example, a microarray can be formed by first identifying the photochemistry required to deposit a DNA sequence. The power required to write the feature, the wavelength, and the feature size can be determined. The RMP can be designed to maximize the absorption by the photoreactive oligonucleotide. A pattern can be drawn on the RMP-CRT that excites various photoactive chemicals, as would a laser shining through a mask in a more traditional photolithographic process. Those regions not illuminated by the RMP-CRT are not activated. For each layer on the chip, a different pattern can be written on the CRT. One embodiment for the synthesis requires a flow-through cell for reagents to pass in front of the RMP-CRT irradiated surface to be modified by the photosynthetic reagents.

RMA CRT Direct Write

Direct Write exposure, using a CRT-RMA projection light source in the lithographic patterning of micro-electronic devices, can be used to eliminate glass masks. Direct write techniques have been made to work in processing semiconductor devices. Pattern generator [PG] software, such as that used for glass mask pattern exposure, can be used with direct write step-and-repeat procedures. The software has to be able to drive the RMP-CRT in a manner that reproduces circuit patterns faithfully. Printed circuit boards (PCBs) and microwave or hybrid circuits operating at 40 to 50 Ghz, for example, are potential applications. An alternative approach to writing or purchasing new software involves employing the use of a video camera to directly photograph a PG photo plot or generated rubylith and transmit the image, optically sized, directly through a CRT-RMA. High end systems are commercially available that can be adapted to such a task. Such an approach can be useful in applications such as PC manufacturing, thick film circuits, and IC packages.

Alignment Keys

Alignment keys are normally incorporated within lithographic patterns of a micro-electronic device. These allow for alignment of subsequent mask levels with pattern levels previously exposed. The use of direct write lithography employing CRT projections introduces a problem because the vehicle for providing the alignment key, usually the glass mask, is not present. The problem can be overcome by employing another unique approach.

A requirement of step-and-repeat exposure systems are the built-in features of an X-Y micro-manipulator stage and a microscope. These provide the mechanical and visual means for aligning overlaying mask levels. In the absence of conventional masks, possessing matching keys at each level, microscope eye-pieces containing etched cross-hair reticles can serve as a surrogate mechanism. Registration derives from the need to remove the substrate from the exposure system repeatedly for multiple processing steps. Where the circuit pattern is to be produced by employing direct-write software, the procedure can be one of aligning the reticle with an alignment key incorporated into the first circuit pattern and etched into the substrate after the first exposure. With this as the reference point, and making use of the reticle eyepiece as a surrogate alignment key, subsequent masking levels can be accurately positioned by realigning to the original key. This can be contingent on the use of common reference co-ordinates for all patterns in the set. In situations where there are an unusually large number of pattern levels, run-out may result from a buildup of oxide, silane or metal over the first level alignment key. This run-out can make it difficult to define what had previously been distinguishable edges. Difficulties normally associated with registration can be minimized or avoided by including an alignment key at each pattern level.

Power Output Requirements

Photoresist used widely throughout the micro-electronics industry, such as photoresist available from Shipley Corporation of Marlboro, Mass. One class of such products can be used with excimer laser light sources, such as for sub-micron feature size applications, which can require 10 to 40 mj/cm² for optimum exposure. There is no obvious reason why this class could not be used in resolving larger feature sizes, enabling it to be used in conjunction with a CRT-RMA. Another class can be used with mercury vapor light sources, such as for less stringent applications, which can require 110 to 210 mj/cm² for optimum exposure.

Face Plate Area

The patterns likely to be dealt with in utilizing present direct write technology need to fit within the 7″ diagonal face plate. There are many potentials users whose patterns will fall well below this size. Some patterns require 0.5″ to 1.0″ for the semiconductor industry and 1.0″ to 2.0″ for semiconductor packages, as well as sizes many multiples of these numbers for thin film, thick film, and PC applications. An optional size smaller than the 7″ rectangular product can be used, such as a 4.0″ diameter round face plate, for example. The advantages are reduced cost, ease of assembly to a step-and-repeat mechanism, and fewer problems associated with optical distortions.

Resonant Microcavity Display

A Resonant Microcavity Display (RMD) is a luminescent display that offers the advantages of a thin-film phosphor without the problem of light piping. An RMD emits light in a highly directional manner as a result of its geometry. An RMD is a structure that modifies spontaneous emission properties of a phosphor contained within the structure. The modification of spontaneous emission is obtained by changing the optical mode amplitudes to such a degree that the phosphor favorably emits into a relatively few optical modes. It is also possible to suppress emission in certain optical modes. This modification of mode amplitudes can be created, for example, by the formation of a standing wave electric field for each favored mode within the structure and locating the phosphor at the anti-nodes of these standing waves. The standing waves can have substantially modified electric field amplitudes relative to the field amplitudes generated without a cavity.

In standing wave cavities, no enhancement occurs at the node of the electric field. However, a ring cavity design can support a traveling wave in which the electric field amplitude is substantially modified throughout the entire cavity. As a result, mode enhancement or suppression can occur throughout the cavity. Compared to the standing wave cavity, more active medium with modified light emission can be utilized for the same cavity volume.

One example of a resonant microcavity display is a microcavity resonator comprising a phosphor sandwiched between two reflectors, all of which are grown on a transparent rigid substrate. The width of the active region is chosen such that a resonant standing wave, of the wavelength to be emitted, is produced between the two reflectors. In its simplest form, a single coplanar microcavity, the two reflectors are parallel to each other and the plane of the active region is parallel to the reflectors. Other geometries which produce standing waves or traveling waves with an increased electric field amplitude, such as combinations of planar microcavities, three-dimensional microcavities, confocal microcavities, hemispherical microcavities, or ring cavities are also possible.

The substrate can be either a crystalline, polymer, or an amorphous solid. It can be made of any material that will allow the other regions to be grown on it. Suitable substrate materials may be chosen from a wide range of materials such as oxides, fluorides, aluminates, and silicates. The substrate material can also be fabricated using organic materials. The criteria involved in selecting a substrate material include its thermal conductivity and its compatibility (both physical and chemical) with other materials forming the RMD.

The phosphor can be excited through several means, including: bombardment by externally generated electrons (cathodoluminescence), excitation by electrodes placed across the active layer to create an electric field (electroluminescence), or excitation using photons (photoluminescence).

Phosphors are materials that exhibit superior visible luminous efficiencies (where luminous efficiency, as used herein, is defined as the ratio of light output in Watts over the power input in Watts). Typically, the luminous efficiencies of phosphors range between 1% and 20%. These high efficiency materials are only classified as phosphors if the material efficiently generates luminescence when excited by electrons, electric fields, or light.

The active region may comprise a wide range of inorganic phosphors (e.g., sulfides, oxides, silicates, oxysulfides, and aluminates) most commonly activated with transition metals, rare earths or color centers. In addition to inorganic phosphors, the active region may employ an organic phosphor such as tris (8-hydroxyquinoline) aluminum complex. The active region comprises phosphors typically in the form of single crystal films, polycrystalline films, amorphous films, thin powder layers, liquids, or some combination of the above.

The reflectors forming the resonant cavity can consist of either metallic layers or Bragg reflectors, for example. Bragg reflectors are dielectric reflectors formed from alternating layers of materials with differing indices of refraction. The simplest geometry for dielectric reflectors consists of one-quarter wavelength thick layers of a low refractive index material, such as a fluoride or certain oxides, alternating with one-quarter wavelength thick layers of a high refractive index material, such as a sulfide, selenide, nitride, or certain oxides. The dielectric reflectors can also be fabricated using organic materials. Mirrors can also be formed using photonic band gap crystals. Any incident light with an energy within the band gap will be reflected by the structure. A microcavity uses multiple reflectors in order for most of the light to be projected towards the viewer. In the case of the simple coplanar microcavity, this asymmetry is obtained by having one of the two reflectors be substantially wholly reflective, meaning that it reflects most of the light impinging on it. The other reflector (opposite to the substantially wholly-reflective reflector) is partially reflective, meaning that it does not reflect as high of a percentage of impinging light as the wholly-reflective reflector and allows some of the light to pass through it. Because of the difference in reflectance of the two reflectors, virtually all of the light produced in the active region escapes through the partially-reflective reflector along the axis normal to the plane of the device. In the case of a microcavity structure, the dimensions depend on the natural spontaneous emission spectrum of the phosphor being used, as observed outside of a cavity. If the spectrum covers a broad range of visible wavelengths it is possible to choose an appropriate part of the spectrum (i.e., one that matches an industry standard chromaticity) and construct the microcavity with a matching resonance. The final chromaticity of the RMD will correspond to the cavity resonance and will be different from the natural chromaticity of the phosphor outside of the microcavity. Conversely, if the phosphor's natural spontaneous emission spectrum covers only a narrow range of visible wavelengths, the dimensions would be chosen so that the cavity resonance would match one of the phosphor's emission bands.

The RMD has a highly directional light output similar to those of a projector or a flashlight and, as a result, RMDs can be constructed to avoid light piping. This allows highly efficient coupling to other devices. RMD's also have a high external efficiency, approaching 100%. Since RMDs incorporate films, RMDs permit the design of efficient thermal conduction of the heat generated in the active layer. This feature combined with the ability to reduce the phosphor decay time allow RPMs to utilize intense excitation. As a result of the above, RMDs are especially suitable for use in printing applications where quick and precise exposure is necessary.

Display

RMDs utilize quantum electrodynamic (QED) theory to enhance the properties of the light emitted from phosphor based luminescence displays. The performance of a given display application depends on properties of the emitted light such as the chromaticity, direction, and flux. These properties can be optimized by employing the principles of QED theory in the design of microcavities so as to control the spontaneous emission characteristics of the phosphor activator for each specific display application.

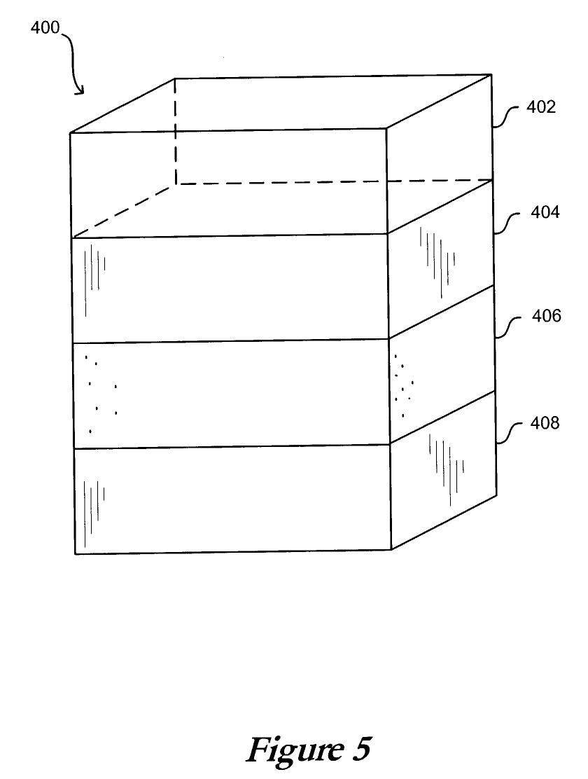

As seen in FIG. 5, one example of an RMP-CRT that can be used in accordance with the present invention comprises a phosphor embedded in a resonant microcavity 400 grown on a substrate 402. The microcavity 400 further comprises a front reflector 404, a phosphor-based active region 406, and a back reflector 408. The active region 406 is disposed between two reflectors 404 and 408. The structure may comprise a variety of materials and may employ a variety of resonator designs. FIG. 5 illustrates a planar mirror design, while other configurations, such as a confocal mirror design, can be used. The confocal design has the advantage of having an inherently higher cavity quality factor (Q). More complex cavity designs involve stacking multiple microcavities.

The properties of an RMD that can be controlled include the chromaticity, the directionality of the display, the luminous efficiency and the maximum light output of the display. These properties can be tuned according to the requirements of the specific printing application. Parameters that can be considered for optimization include the microcavity Q, the microcavity resonance frequency, the asymmetry of the reflectors, the resonator design (i.e., planar, confocal, multiple cavity, etc.), the phosphor, the thickness of the phosphor layer, the surface area of the microcavity and the excitation source. While these parameters can be optimized separately, care should be taken as each parameter affects the other adjustable properties of the display.

For most printing applications, only one side of the microcavity will be used. In these applications one can choose reflectors with different reflectivities, such that the display preferentially forces the light out the cavity towards the viewer.

There exists an entire set of parameters to consider including the individual mirror reflectances and individual cavity Q's. In addition, one must also determine the cavity spacing, coupling layer, and the location of the phosphor material. The exact specifications will depend on the specific display requirements. A primary design specification of the RMD is the chromaticity of the emitted light. The center frequency and linewidth of the cavity must be engineered so that the RMD displays this color of light.

Once these parameters are selected, the phosphor must be selected. The phosphor will need to have a natural luminescence resonance that overlaps the cavity resonance. As the resonance narrows and the overlap increases, the display efficiency and brightness increase. A compromise between chromaticity and other parameters may be required to optimize a display for a specific application.

The intensity of light emitted by the phosphor is related to the activator concentration: as the concentration increases, the intensity of emitted light increases. The activator concentration, however, is often limited by non-radiative energy transfer between activators that quenches luminescence. These quenching effects are concentration dependent. The quenching concentration varies from phosphor to phosphor, depending on the magnitude of various energy transfer parameters between activators.

The display properties also depend upon the thickness of the active region. Depending on the cavity design, there may be several active region thicknesses that produce a predetermined frequency. The range of thickness depends on the mirror construction. As the thickness increases, the number of potentially excited activators increases. With sufficient excitation energy, the total luminescence can be increased with a wider active region. However, the thickness may alter the spatial distribution in a highly complex manner. In the case of a simple coplanar microcavity, the angular spread of the light changes, with additional regions of high intensity appearing at angles that are not normal to the plane of the microcavity. More complex multiple cavity designs allow a greater degree of control over the directionality of the display.

Another key parameter in the resonant microcavity design is the area of the emitting surface. Some printing applications may require one large-area surface for the production of monochromatic light, while other designs will need pixel-sized cavities capable of producing red, green and blue light. The size of the pixel can be determined by the resolution requirements of the display.

One other important parameter is the excitation source and intensity. The display application will dictate the excitation source. The decision process in selecting the phosphor must also consider the efficiency of converting the excitation energy into useful luminescence. This efficiency is well documented for the registered phosphors, but can easily be experimentally determined. The intensity of the source will primarily change the brightness.

An RMD design can utilize an optical element, such as a lens or a diffuser, fabricated within or on top of the substrate of a resonant microcavity. For example, a lens could be used to modify the angular distribution of the light output produced by the structure and thereby generate the required distribution. The lens can be formed using photo-etching methods, which are well known in the art of miniature semiconductor lasers. Another method could employ the controlled placement of impurities to change the local refractive index. This method is used to construct gradient refractive index lenses which are commonly used in fiber optics.

Similarly, a diffuser can be used to precisely control the angular spread of the light and thereby the field of view of the display. With the ability to control the light distribution independent of the microcavity, the spontaneous emission properties of the phosphor can be maximized without having to consider the required light distribution. A diffuser can be made using holographic techniques, ruled grating techniques, introduction of internal scattering centers, or precisely controlled surface roughening.

An RMD approach is superior to conventional printing methods because an RMD provides intense excitation loading of the phosphor, highly directional output, controlled chromaticity, and high external efficiency. The RMD allows the use of a relatively compact CRT while maintaining high luminescence.

In the case of a resonant microcavity display incorporated in a CRT, the phosphor is excited by electrons emitted from the electron gun, accelerated to a speed such that most of them will penetrate the resonant microcavity to the depth of the phosphor. The high energy electrons excite electrons in the phosphor from the valence band into the conduction band. This additional energy is trapped at the impurity. The impurity then relaxes by emitting visible light.

In the case of a simple coplanar microcavity, the reflectors can be either dielectric or metallic. The back reflector has a higher reflectivity than the front reflector, so that light, emitted by the phosphor, exits the cavity through the front reflector, perpendicular to the plane of the thin film device. The microcavity Q and the asymmetry in the reflectance determines the percentage of light that exits the resonator through the front reflector.

In the case of the simple coplanar microcavity, the width of the active region affects the directionality of the light and is chosen so that its optical path length, i.e, the product of the distance between the back reflector and the front reflector and the index of refraction of the phosphor material, equals an integer multiple of the desired wavelength divided by 2 or 4 depending on the index of the adjacent layers. These dimensions ensure that a standing wave builds up between the back-reflector and the front reflector. The wavelength of the emitted light is determined by the resonant wavelength of the microcavity.

The parameters chosen to optimize the output depend on the required brightness and directionality of the light output. In the typical printing application, the output should be highly directional and bright. The output efficiency can be optimized empirically by measuring the total intensity emitted in the useful direction as a function of the electron beam current.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A method of creating micro-patterns on a planar surface, comprising:
processing an image as a series of signals;
providing the series of signals to a resonant microcavity phosphor display; and
scanning an electron beam from the resonant microcavity phosphor display over a photo-sensitive surface according to the series of signals.

2. A method according to claim 1, wherein the step of scanning an electron beam includes scanning an electron beam over a photo-sensitive surface selected from the group consisting of printed circuit board components, photoresist-covered substrates, photosensitive biological molecules, photosensitive chemical compounds, and ink-sensitive plates.

3. The method of claim 1, further comprising:
generating the image using a video imaging camera.

4. The method of claim 1, wherein the step of scanning does not involve contacting the photo-sensitive surface with the resonant microcavity phosphor display.

5. The method of claim 1, wherein the step of scanning an electron beam includes scanning an electron beam in a raster pattern.

6. The method of claim 1, wherein the step of scanning an electron beam includes scanning an electron beam over each feature of the pattern individually.

7. The method of claim 1, wherein the step of providing the series of signals includes providing the series of signals to a collimated resonant microcavity phosphor display.

8. The method of claim 1, wherein the step of scanning an electron beam includes scanning an electron beam once over the surface.

9. The method of claim 1, wherein scanning an electron beam from the resonant microcavity phosphor display over a photo-sensitive surface according to the series of signals forms microarray features by synthetic photochemistry.

10. The method of claim 1, wherein scanning an electron beam from the resonant microcavity phosphor display over a photo-sensitive surface according to the series of signals forms lab-on-a-chip style microanalysis chips by wet-etching.

11. The method of claim 1, wherein scanning an electron beam from the resonant microcavity phosphor display over a photo-sensitive surface according to the series of signals forms “virtual wells” arrayed on a solid support by surface tension.

12. The method of claim 1, wherein scanning an electron beam from the resonant microcavity phosphor display over a photo-sensitive surface according to the series of signals forms a bioanalysis chip.

13. A system for creating micro-patterns on a surface, comprising:
an image processor for processing an image as a series of signals;
a resonant microcavity with an active region, the active region having a phosphor disposed therein for emitting light onto a photosensitive surface; and
a cathode ray tube to generate exciting electrons for exciting said active region.

14. The system of claim 13, wherein said microcavity can modify a spontaneous emission processes of the phosphor.

15. The system of claim 13, wherein said microcavity can modify an energy transfer processes of the phosphor.

16. The system of claim 13, wherein the phosphor comprises a dopant within the microcavity disposed in a region of the microcavity having a substantially modified electric field amplitude.

17. The system of claim 16, wherein said microcavity is dimensioned to produce a traveling electromagnetic wave having the substantially modified electric field amplitude.

18. The system of claim 13, wherein the microcavity comprises a structure selected from the group consisting of coplanar microcavities, three dimensional microcavities, and combinations thereof.

19. The system of claim 13, wherein the microcavity comprises a structure selected from the group consisting of confocal microcavities, hemispherical microcavities, and ring cavities.

20. The system of claim 13, wherein said microcavity is excitable to establish the substantially modified electric field amplitude inside said microcavity.

21. The system of claim 13, wherein the resonant microcavity comprises thin films.

22. The system of claim 13, wherein the microcavity is comprised of:
a substrate; and
a structure disposed upon said substrate including said active region and a plurality of reflective regions.

23. The system of claim 22, further comprising a plurality of said microcavities, each of said plurality of microcavities having a resonant region therein, and said microcavities are operatively coupled to form a larger resonant region.

24. The system of claim 23 wherein the plurality of reflective regions comprise:
a front reflective region disposed upon said substrate, and
a back reflective region;
wherein the active region is disposed between the front and the back reflective regions.

25. The system of claim 13 wherein said active region comprises a phosphor selected from the group consisting of sulfides, oxides, silicates, oxysulfides, and aluminates.

26. The system of claim 25 wherein said phosphor includes an activator comprising a material selected from the group consisting of transition metals, rare earths, substances having color centers, and combinations thereof.

27. The system of claim 13 wherein the thickness of the active region is equal to a selected wavelength of light to be emitted multiplied by an integer and divided by the quantity 4 times the index of refraction for light of the selected wavelength in a material comprising the active region.

28. The luminescent display of claim 13 wherein the microcavity comprises a plurality of active regions and the thickness of the plurality of active regions is equal to a selected wavelength of light to be emitted multiplied by an integer and divided by the quantity 4 times the index of refraction for light of the selected wavelength in a material comprising the plurality of active regions.

29. The system of claim 13 wherein said resonant microcavity comprises a photonic band gap material.

30. The system of claim 13 further comprising means for generating a predetermined angular light distribution from light emitted from said active region.

31. The luminescent display of claim 30 in which said means for generating the predetermined angular light distribution comprises a structure selected from the group consisting of lenses, diffusers, holographic elements, gradient index elements, and combinations thereof.
